(19) United States
(12) Patent Application Publication
(10) Pub. No.: US 2026/0115580 A1
(43) Pub. Date: Apr. 30, 2026

(54) MACHINE FOR REMOVING FILM LAYERS FROM CARD STOCK

(71) Applicant: Lottomatrix Operations Limited, St Julians (MT)

(72) Inventors: Nikolic Dejan, Belgrade (RS); Aleksandar Mirkovic, Ruma (RS); Steva Vojnovic, Ruma (RS); Milan Brasancevic, Ruma (RS); Ivan Jurcanin, Maradik (RS); Ljubomir Romcevic, Ruma (RS)

(73) Assignee: Lottomatrix Operations Limited, St Julians (MT)

(21) Appl. No.: 19/174,565

(22) Filed: Apr. 9, 2025

Related U.S. Application Data
(60) Provisional application No. 63/711,885, filed on Oct. 25, 2024.

(51) Int. Cl. A63F 3/06; B08B 1/12; B08B 5/02

(52) U.S. Cl. CPC A63F 3/068; B08B 1/12; B08B 5/02

(57) ABSTRACT

A device to automate the removal of a layer of opaque film applied to a card stock to obscure printed information residing underneath the film layer without introducing damage to the card stock itself that would significantly impair access to the printed information after such removal.

This is a utility patent application claiming priority to U.S. Provisional Application No. 63/711,885 filed on Oct. 25, 2024 and U.S. Provisional Application No. 63/681,378 filed on Aug. 20, 2024, both of which are incorporated by reference.

### FIELD OF INVENTION

This invention relates to a machine that can be used to automate the removal of a layer of opaque film applied to a card stock to obscure printed information residing underneath the film layer without introducing damage to the card stock itself that would significantly impair access to, display of or use of the printed information after such removal.

### BACKGROUND

Payment cards, voucher cards, one-time betting cards, contest cards or other gaming cards and the like can utilize a pre-printed symbol, comprised of a number, alphanumeric strings or imagery that are printed on the card before the card is distributed or sold. This printed symbol may be obscured with an opaque film substance layered on top of the region of the card that the symbol is printed on so as to obscure it, often for security reasons or in the case of gaming, to prevent cheating. The film layer may be comprised of removable latex ink, acrylic, plastic, metal powder and/or cellulose that adheres to the card, either as a result of the material itself having adhesive properties or through use of an intermediate adhesive layer such as a light or temperature cured adhesive. Upon purchase or other use, a user can then scrape the film layer off, thereby exposing the symbol, whether it be a number, alphanumeric strings or imagery that was already printed on the card in that region. These cards are often manufactured in a secure way and each card is used once.

Similarly, there is now wide adoption of electronically distributed data payloads that operate in many ways that are analogous to these kinds of gaming cards, essentially acting as a virtual gaming card. As a result, computer systems permit the purchase of electronic, virtual gaming cards, that are not literally cards, but a data payload. The authorized issuer of the gaming card maintains secrecy and security over the cards and their pre-printed symbols by only distributing hard-copy, pre-printed gaming cards. In order to interoperate between these two regimes, there may be automatic systems that process the virtual gaming card while providing a user access to the corresponding physical gaming card remotely, through a computer network from an application or “app” operating on their personal device. There is a need for a machine that can automatically conduct the scraping function of the physical card in order that the pre-printed symbol be exposed, detected, converted to a digital data and that data is then associated with an electronic transaction involving the corresponding virtual gaming card. Further, as the virtual gaming cards have become more popular, such a machine must to be designed for operation with a significant rate of cards scraped per minute. In addition, many gaming cards are purchased that may represent a winning wager. Therefore, the physical card may represent value such that the machine conducting the scraping action must to be sufficiently reliable that the physical cards are not damaged in a way that introduces liability or costs arising from lost wagers. In an operation that seeks to automate the use of these physical gaming cards, there is a need for a machine that can remove the film automatically, at a substantial rate and with substantial reliability.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1 is a side view of the machine, with the card moving from right to left. 3.1 is the removable blade on 3.2, the blade holder.

FIG. 2 is a close up of the scraping tool, card and power wheel when the scraping tool is engaged.

FIG. 3 is a close up side-view of the scraping tool in operation indicating the range of pressure of the scraping tool against the card.

FIG. 4 is a close up side view of a portion of the rubber layer on the power roller indicating the range of hardness or resiliency of the rubber layer comprising the power roller.

FIG. 5 depicts a side view of the scraping tool dimensions: FIG. 5A shows the range of angle between the top surface of the scraping tool and the tangent to the circular concave collection region at the front edge of the tool. FIG. 5B shows the range of angle between the top surface of the scraping tool and the bottom point of the concave collection region.

FIG. 6 is a perspective view of the scraping tool showing the lateral width dimensions of the tool.

FIG. 7 an embodiment of the system utilizing an opto-electronic sensor.

FIG. 8 shows the internal mechanical arrangement of the hydraulic cylinder.

FIG. 9 shows the system architecture for the control system.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

One embodiment of the machine is comprised of the following elements:
Encoder Wheel: an element for activation and deactivation of a scraping tool that scrapes the card.
Power Wheel: a roller wheel that causes movement of the card material over the scraping tool and ensures adequate pressure and angle of the scraping tool on the card stock.
Scraping Tool: a blade assembly that removes the film layer from the card stock, the tool being comprised of a replaceable blade and a blade holder.
Brush roller: a spinning brush assembly that cleans the scraping tool of any detritus from the scraping action.
Waste Box: an open container that collects the acrylic detritus generated by the processing of the cards.
Movable Wedge: a device with an inclined surface that allows precise positioning of the scraping tool in relation to the card stock and further translates lateral motion of the Drive Cylinder into vertical motion of the Scraping Tool.
Drive Cylinder: is a hydraulically or pneumatically driven device that actuates the Movable Wedge upon application of air pressure.
Etalon: a replaceable and adjustable element that sets the exact final position of the replaceable Movable Wedge and thereby the Scraping Tool and can be adjusted to accommodate different thicknesses of card stock and different desired pressures of the card stock against the Power Wheel during processing.
Stage Plate: is the planar element on which the card stock travels as it passes through the machine.
Card Stock: the card stock is a card with printed symbols on at least one side, which at least some of which are obscured with an opaque layer that faces toward the scraping tool.
Film Layer: is the opaque removable layer on the card, typically made of acrylic, that obscures the printed symbols behind it. This is the layer that is removed by the scraping tool.

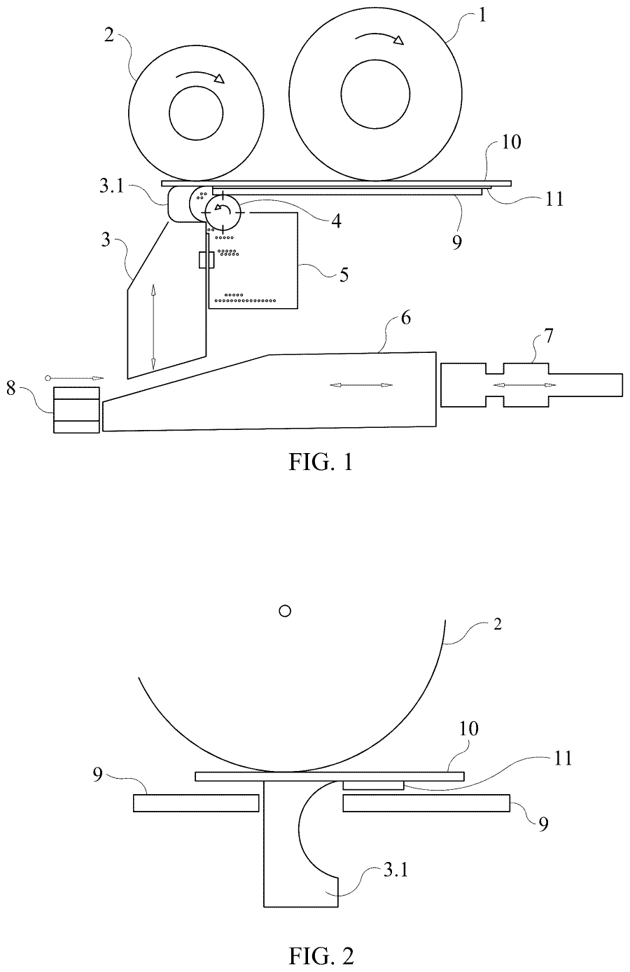

The card (10) enters the machine as depicted in FIG. 1 from the right. The card (10) is comprised of the film layer (11) coated on the card stock gaming card. The card is oriented so that the film layer is facing down toward the scraping tool. The card slides along a horizontal stage plate (9) comprised of a smooth and rigid material such as steel, acrylic or other sufficiently strong material. The replaceable card is oriented longitudinally such that the scraping tool (3) slides laterally along the longer axis of the film layer region (11). The machine is comprised of a card location sensor, that determines when the border of the film layer region (11) is positioned proximate to the edge of a scraping tool (3.1). In one embodiment the card location sensor is an encoding wheel (1) that detects the presence and relative position of card (10) and its film layer (11). As the card (10) transits the stage plate (9) the encoding wheel, by virtue of contact with the card (1) rotates in the direction of card motion. That rotation may be detected by electronic sensors in a variety of ways. For example, the axle of the wheel (1) may be mechanically coupled to a rotational position switch that encodes its angular position into an analog signal or digital signal. It may be a mechanical electrical switch that is mechanically coupled to the wheel, such that as the wheel rotates, it engages the switch at the correct position of the card, and the switch causes a voltage to be delivered to a logic input at the controller. Alternatively, the wheel or a rotating member attached to its axle may be comprised of light reflective paint at one position, so that a combination of a light source and photo diode can generate a signal indicating a predetermined position of the card as the encoding wheel rotates. That signal can be received by the logic of the controller. The machine is therefore comprised of an electro-mechanical feedback subsystem that detects the position of the card relative to the scraping tool. That position may be when the first edge of film layer (11) reaches the scraping tool (3).

Scraping tool (3) is preferably comprised of surgical steel, but may be comprised of any metal or other substance of sufficient hardness to avoid being deformed by the action of the machine. The stage plate (9) is positioned opposite the encoding wheel (1) and has an opening proximate to the location where the scraping tool (3) engages the card (10) while the scraping tool is pressing the card against the power wheel (2). The opening is of sufficient size to permit the scraping tool edge to move against the card when the card is at the appropriate position. When the encoding wheel (1) or other electro-mechanical feedback subsystem generates a signal indicating that the position that the border of the film layer (11) has reached a position sufficiently close to the edge of the scraping tool (3), that signal may be used to engage an actuator that pushes the scraping tool (3.1) towards the power wheel (2) and thereby against the card. In one embodiment, the actuator is engaged by a compressed air valve that opens in order to introduce pressure on the drive cylinder (7). As depicted in FIG. 1, the drive cylinder is thereby pushed to the left.

The drive cylinder (7) pushes the moveable wedge (6) to the left. The movable wedge (6) is slidably coupled to the framework of the machine so that it may smoothly move left and right in response to the drive cylinder. The moveable wedge (6) is comprised of an inclined plane which transfers force and motion transversely into the axis of the scraping tool mount (3). Resting on the inclined plane is the mounting for the scraping tool (3.1). In one embodiment, the scraping tool mounting is comprised of an inclined plane, with an angle that sufficiently matches the angle of the inclined plane of the moving wedge (6) so that as the wedge moves left, the tool mounting and therefore the scraping tool is pushed up, toward the card. One of ordinary skill will understand that “left” is a matter of perspective of the drawing and the invention encompasses any embodiment with a complementary direction of the card moving “right.”

When the scraping tool (3.1) is pushed up toward the card (10), the card will reside between the running face of the scraping tool and a rubber power roller (2). At that point, the power roller has sufficient frictional hold on the card that the power roller (2) pulls the card across the scraping tool cutting edge (3.1). With that motion, the scraping tool edge cuts into the film layer (11) and scrapes it off of the card (10). The scraping tool (3.1) has sufficient lateral width so that the entire width of the film layer is scraped off in one motion. See FIG. 6. In the preferred embodiment, the lateral width of the scraping tool (3.1) is between about 100 mm to about 200 mm.

While the scraping process occurs, the detritus arising from the film layer is generated. Typically this is in the form of particles of acrylic, plastic, metal powder and screen printed image coating. This detritus has to be removed, preferably continuously as the machine operates. In order to maintain the continuous operation of the device, a cleaning mechanism is provided to remove detritus from the scraping action. In one embodiment, the cleaning mechanism is a rotating brush, preferably comprised of spiral bristles extending out from a cylindrical member (4) which cleans out the collection area behind the edge of the scraping tool. The rotating member (4) has a rotational axis that is substantially parallel to the plane of the stage plate. Situated proximate to the backside of the brush is a waste collection box (5) where the detritus is collected for occasional disposal. In one embodiment, the circular profile of the brush motion (4) fits within the concave cavity on the front face of the cutting tool (3.1).

The relationship between the moveable wedge (6) and the position of the scraping tool when engaged may be one that needs careful adjustment. This may be accomplished with the etalon mechanism (8) that can set a maximum engagement of the scraping tool mount (3) when the wedge (6) is driven by the cylinder (7).

In the preferred embodiment, the air pressure and angle of the inclined plane comprising wedge (6) are combined such that when engaged, the force of the scraping tool normal to the card and stage plate plane is between about 0.110 kN and about 0.210 kN. See FIG. 3. In other embodiments, the pressure may be set by means of a spring or piston that engages the axle of the power wheel (2) in a direction perpendicular to the plane of the stage plate (9) while the scraping tool (3) remains stationary.

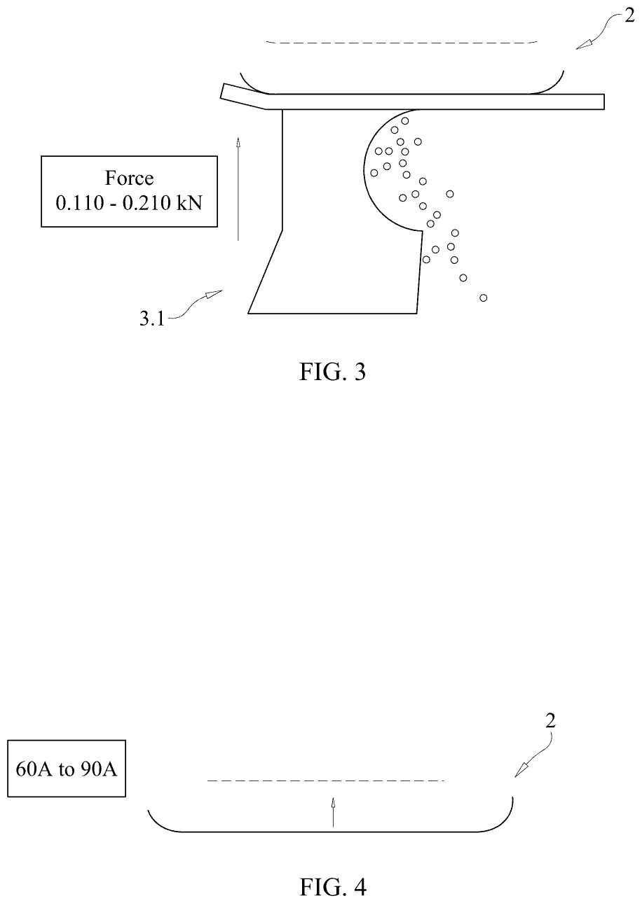

In the preferred embodiment, the rubber or gum layer material comprising the power wheel (2) in contact with the card (10) is of Shore A scale hardness of between about 70 (A) to about 80 (A). See FIG. 4. In some embodiments the hardness of the surface of wheel (2) is about 60 to about 90 (A) The power roller (2) must not be damaged by the scraping tool, and it must keep proper pressure. The hardness of the rubber surface must be soft enough to grab and move the card, and also hard enough to resist the cycling of the tool without damage to the wheel. Damage to the card will result if the power roller is too hard.

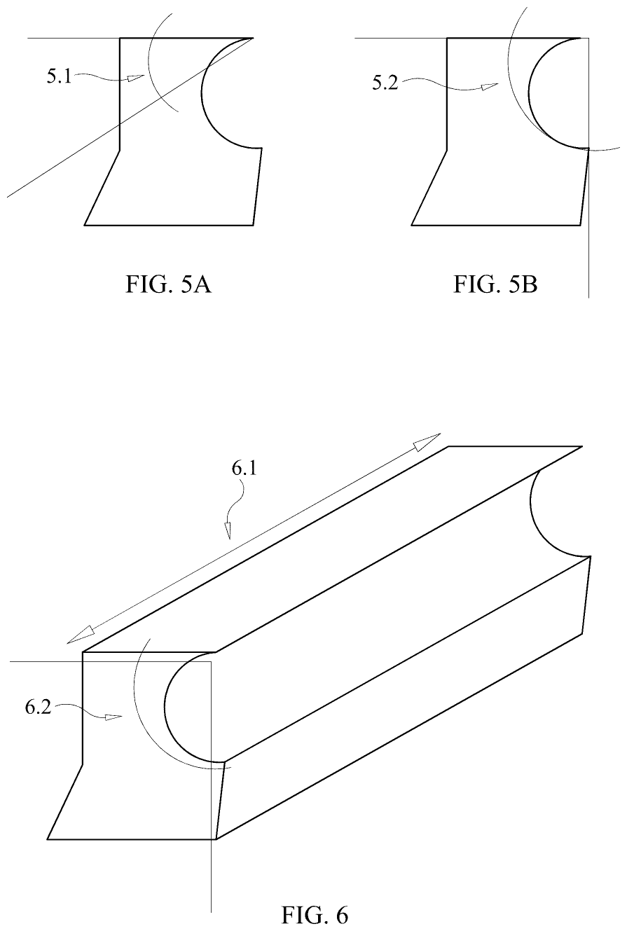

The shape of the scraping tool is depicted as a side view in FIG. 5. The scraping tool (3.1) is flat and planar on top, parallel to card surface. In the preferred embodiment, the angle between the top surface plane of the scraping tool and the line tangent to the recessed arc profile of the collection region at the edge point of the scraping tool is between about 38 degrees and 60 degrees. In other embodiments, the angle between the top surface plane of the scraping tool and the line tangent to the recessed arc profile of the collection region at the edge point of the scraping tool is between about 2 degrees and 90 degrees. See FIG. 5A. The tangent angle at 45 degrees is also may be used. If that angle is greater so that the edge is steeper, it may increase wear on the rubber power wheel. If that angle is too shallow, detritus is more likely to stay on the tool and impede its continuous operation. In addition, if the scraping edge is too thin, it is more fragile which may result in damage to the tool and thereby damage to the power wheel and one or more cards.

In the preferred embodiment, the angle between the top surface plane of the scraping tool and the line running from the front edge of the scraping tool to the intersection of the circular profile of the collection region and the front face of the scraping tool is about 85 degrees to 90 degrees. See FIG. 5B.

In some embodiments, the wedge (6) actuator may be driven by a solenoid mechanism with a spring that upon an electrical pulse, pushes the wedge to the left. In other embodiments, a mechanical motion can convert the rotation of the gum power wheel to a horizontal motion that moves the wedge (6) such that the two mechanisms are coupled. Other ways of driving the wedge may include a stepper motor and screw, whereby the axis of the screw is parallel to the longitudinal axis of the wedge. In yet other embodiments, the scraping tool (3.1) is mounted on a hydraulically or pneumatically driven piston or solenoid driven member that directly presses the scraping tool against the card when actuated by the programmable logic controller (PLC) (903) at the time the card is to cross the open region of the stage plate (9).

In some embodiments, the encoding wheel and power wheel rotate at a sufficient rate to process a card between every 3 seconds to every 10 seconds.

In some embodiments, the brush roller (4) may be replaced or supplemented with a compressed air nozzle that is also driven by the encoding wheel (1) or other electro-mechanical feedback mechanism so that at the appropriate time, typically upon completion of a card being scraped, the detritus is blown away from the scraping tool by means of the feedback mechanism actuating a valve controlling a feed of compressed air to a nozzle pointing at the region proximate to the cavity formed by the cutting tool (3.1). In other embodiments, a vacuum hose is operably attached to the waste box (5) to vacuum the detritus from the collection region of the scraping tool.

Upon completion of the scraping step of the process, the card passes to the left. At a predetermined time determined by the electro-mechanical feedback mechanism, the wedge (6) moves back to the right, and thereby the scraping tool (3.1) moves down away from the stage plate and power roller (2). In some embodiments, the brush roller (4) is mechanically isolated from the scraping tool mounting (3) so that when the scraping tool moves away from the stage plate, the collection region in the cavity formed by scraping tool (3.1) becomes operationally proximate to the brush roller (4), such that the spinning brush roller can clear the detritus from the scraping tool. In other embodiments, the air pressure valve controlling a nozzle pointing at the cavity is actuated by the electro-mechanical feedback mechanism so as to blow air at the scraping tool (3.1) to clean it and clear the proximate region of the stage plate (9).

In some embodiments, the adjustment (8) can be a vernier screw that moves the etalon horizontally as the vernier rotates. The vernier adjustment may be made using an electric motor controlled by a computer such that the computer can select the position of the scraping tool in response to determining the type of card being processed. Changes of the tool position when in the scraping position may be between 0.01 mm to 3 mm, depending on the type of card.

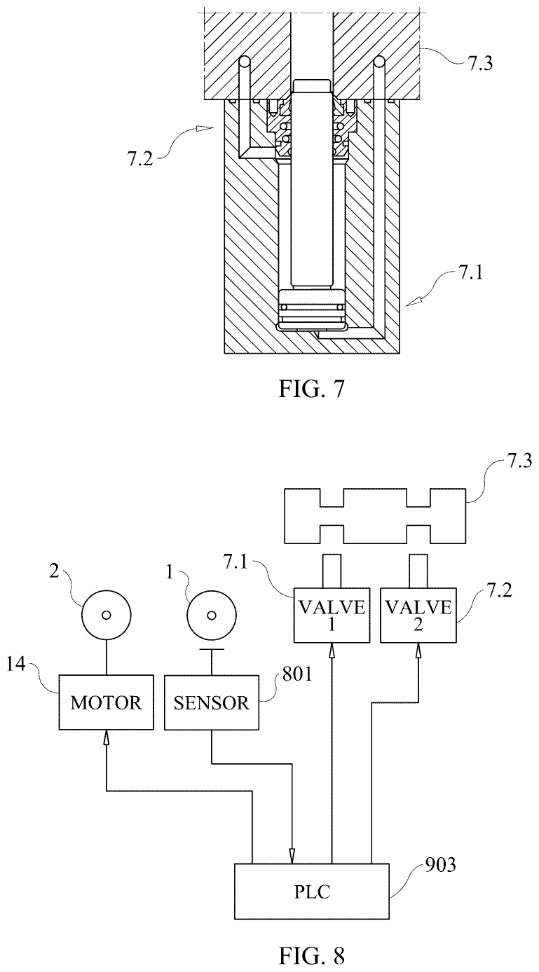

In some embodiments the rotating encoding wheel (1) can be replaced with a photodiode and light source that reside on opposite sides of the stage plate (9). These would be positioned at a location relative to the scraping tool such that as the card moves, the light circuit is broken at the exact point when the scraping tool is to exert pressure and movement against the film layer. (FIG. 7.) In this embodiment, a light sensor or photodiode (12) is situated across the path of the card (10) from a light source (13). When the trailing edge of the card (10) passes the light sensor (12), effectively unblocking the light source, the light from the source (13) falls on the sensor (12) thus generating a signal that is coupled to the PLC (903), either by means of a wire or by a wireless data network. The PLC (903) operates its logic to generate a control signal that is then transmitted to the motor (14) that drives the power wheel (2) and to the mechanical system that causes the scraping tool (3.1) to engage against the card (10). More than one opto-electronic sensor may be used, (12) each positioned to detect a different position of the card, and each coupled to the PLC in order to utilize the multiple sensor outputs to control the power wheel (1) and the scraping tool (3.1).

When the card (10) has travelled across the scraping tool (3) such that the film layer region (11) has passed the edge of the scraping tool (3) the card position sensor, for example the encoding wheel, or opto-electronic sensor, may cause the signal or electrical switch to reposition the wedge (6). In one embodiment, the first compressed air valve is closed so as to vent the air pressure. In another embodiment, a second compressed air valve is opened in order to introduce air pressure that drives the drive cylinder (7) in the opposite direction. As a result, the wedge moves back to the right and the scraping tool (3) moves away from the card (10). In one embodiment, the motion of the scraping tool is vertical, such that gravity drops the scraping tool. In other embodiments, spring elements are used that pull the tool away from the card when the drive cylinder has been deactivated. Cards may be processed rapidly in this sequence: a card drops off a stack on to the stage plate, is pushed toward the encoding wheel, which captures it, and moves it to the power wheel at the appropriate time, the scraping tool is engaged as the power wheel moves the card across the tool. When the scraping is complete, the scraping tool (3) retracts, the power wheel (2) ejects the card (10), the cleaning brush (4) cleans the tool and the machine is prepared to receive the next card.

In yet another embodiment, the stage plate continues past the power wheel, that is, to the left of the power wheel as depicted in FIG. 1. In this embodiment, the stage plate may have a void, gap or slot in it such that as the card moves away from the power wheel, the scraped region of the card is exposed to the void. In this manner, the printed symbol may be visible through the void in the stage plate. In yet another embodiment, an image sensor device may be placed at or proximate to the void such that once the printed symbol becomes optically detectable through the void, the imaging device or computer vision system can capture digital data representing the printed symbol. That digital data can be processed by a computer that is operationally connected to the imaging device using image processing software that can extract alphanumeric data or the logical presence or absence of some symbol. In this way, the physical gaming card and its encoded symbol can be converted into an digital electronic version of the same card. That digital electronic version of the card can be stored in computer memory a data structure that is comprised of an identifier that uniquely identifies the card and the extracted data.

In another embodiment, the electro-mechanical system is modified to control the procession of the card stock (10) across the working tool (3). In this embodiment, the card stock (10) is processed at least twice across the working tool (3). In this embodiment, the power wheel (2) is reversed to bring the card (10) back to the start of the bar-code region to be scraped. Then the power wheel (2) is reversed again to scrape the bar-code section a second time. The reversal motion acts to cleans the bar code of the detritus generated by the first pass, and thereby the second pass produces a cleaner or more complete result. Furthermore, the detritus may get stuck on the surface of item, the blade, or scraping tool that the card slides across, so the reversal of the card causes the detritus to drop down into the cleaning region.

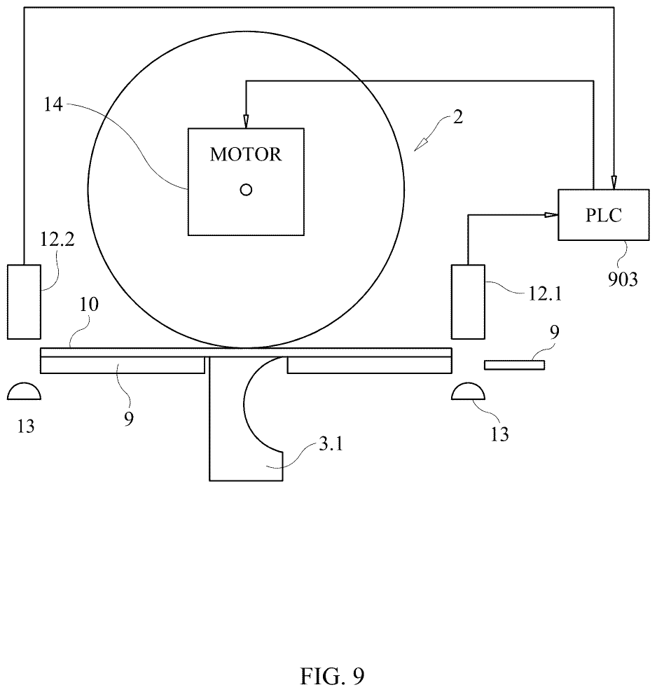

The electro-mechanical system, shown in FIG. 9, comprising the invention has several interacting components to achieve this multiple pass process. The detection wheel sensor (902) detects the end of the card (10) when it passes because the wheel (1) stops rotating. The rotational motion and/or lack thereof is detected by a programmable logic controller (PLC) (903) that then changes the control signal of the motor (901) that drives the power wheel (3) to make it reverse direction after a predetermined period of time, typically between about scrapped 78 milliseconds to 1 second. In other embodiments, the predetermined delay time is zero to 5 seconds. The amount of delay time is dependent on the location of the bar-code, identifying image or printed symbol on the card stock and the length of the card stock being processed. The predetermined delay time can be set in the PLC for a given type of card being processed in a batch.

In yet another embodiment, the detection wheel (1) may be used to detect the position of the card instead of utilizing a predetermined delay time. An alternative embodiment to that is use of an optoelectronic sensor that detects the edge of the card at a location along the stage plate, said sensor coupled to the PLC. In this embodiment, when the PLC detects the end of the card at the location of the opto-electronic sensor, it then reverses the power wheel (2).

The PLC (903) may be programmed to control the process as follows.

Encode wheel (1) measures distance of the card travelling along the stage plate (9) until card (10) is between power wheel (2) and scraping tool (3.1). At that point, the PLC (903) engages the hydraulic valve (904) to push the cylinder (7) and wedge mechanism (6) and thereby the working tool (3.1) is vertically engaged towards the power wheel (2) when card (10) is now correctly positioned for the scraping action.

On the first pass, encoding wheel (1) stops rotating once the card is no longer in contact with it and the rotational signal from the sensor (902) at the PLC (903) indicates it has stopped. The PLC runs a timer for a predetermined time between when the encoding wheel (1) stops rotating, and when the card (10) is still engaged by the power wheel (2) but close to the trailing edge of the card. The motor (901) is still rotating the power wheel during this time.

At the end of a first predetermined period of time, the PLC then changes the direction of the power wheel (2) by reversing the motor (901) to reverse the direction of the card. The working tool (3.1) is still engaged against the card stock (10).

The PLC maintains this state of motion for a second predetermined period of time that based on the speed that the power wheel (2) causes the card to move along the stage plate (9) back to a position where its leading edge of the card (10) is engaged by the power wheel (2).

At the end of the second predetermined period of time, the PLC then changes the direction of the power wheel motor (901) to cause the card (10) to pass over the working tool (3) again.

As the card (10) passes over the scraping tool (3), the PLC (903) at a predetermined point in the trajectory reverses the hydraulic pressure on the drive cylinder (7) by the pressure valve (905) so as to bring the scraping tool (3) down away from the power wheel (2). This happens before card (10) is completely ejected so as to protect the power wheel (2) from the scraping tool blade (3). This ensures that the scraping tool is not directly engaged against the power tool when there is no card (10) in between, thereby protecting the power wheel from damage. The predetermined point in the trajectory may be determined by the PLC counting a third predetermined period of time. Alternatively, an optoelectronic sensor (12) that is operationally coupled to the PLC may be used to detect the position of the leading edge or trailing edge of the card relative to the position of the scraping tool (3) and power wheel (2).

The detritus created by the scraping action may be cleared using a rotating brush (4). In other embodiments, the PLC can control an air pressure valve that controls a flow of air directed from the top of the stage plate toward the waste box (5). In this embodiment, when the card (10) is clear of the scraping tool (3), the compressed air is applied to blow the detritus down into the waste box (5). Alternatively, a tube bearing a vacuum air flow may be placed in the region under the stage plate (9) to suck the detritus away from the working tool (3).

The drive cylinder (7) is controlled using hydraulic valves engaged by the PLC. In one position, the air pressure applied to one side of the cylinder flange mechanism pushes it to the left, as drawn in the figures, while the PLC can reverse its direction by applying the air pressure to the other inlet connected to the other side of the cylinder flange.

The speed of the power wheel (2) is adjusted so that the card stock (10) travels between and including 15 mm/.second and 95 mm/second. The scraping tool (3) position and wedge mechanism (6) is adjusted by the etalon (8) so that the force of the working tool against the card stock (10) when engaged is between and including 0.110 kN and 0.210 kN. The power wheel (2) may be between and including 40 mm and 80 mm in diameter. The rotational speed of the power wheel (2) is between and including 18 and 25 RPM. The hardness of the rubber comprising the surface of the power wheel (2) is between and including 60 Shore A and 90 Shore A. The tangent angle of the curve of the working tool blade surface as it meets the top, horizontal surface of the working tool is between and including 38 degrees and 60 degrees. The logic controller may be a programmable logic controller (PLC) that actuates control of the piston and motor in response to positioning signals received from the wheel. In some embodiments, a Samba 3.5™ PLC or other comparable controller device may be used.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the design and scope of the invention as defined by the following claims.

What is claimed:

1. A machine for removing a film layer region comprised of a border from a card stock comprising:
a power roller;
a stage plate, comprised of a planar surface that is parallel to the axis of the power roller whereby in use the card stock moves along the stage plate toward the power roller;
a card position sensor that in use detects the condition that the border of the film layer is proximate to the position of the scraping tool edge; and
a scraping tool comprised of an edge, said scraping tool moveable along an axis perpendicular to the plane of the stage plate, said scraping tool operationally coupled to an actuator that moves the scraping tool toward the power roller through an opening in the stage plate, said opening proximate to the power wheel and such movement made in response to the card position sensor detecting that the border of the film layer is proximate to the position of the scraping tool edge.

2. The machine of claim 1 where the scraping tool when engaged is between 0.01 mm and 3 mm from the power wheel.

3. The machine of claim 1 where a force of the scraping tool against the card when the scraping tool is engaged is between about 0.110 kN and about 0.210 kN.

4. The machine of claim 1 where the scraping tool is comprised of a top substantially planar surface, an edge and a cross section profile that is comprised of a substantially concave shape.

5. The machine of claim 4 where a line tangent to the concave shape at the edge point of the scraping tool is between about 2 degrees and 90 degrees from the planar surface of the scraping tool.

6. The machine of claim 5 where the line tangent to the concave shape at the edge point of the scraping tool is approximately 45 degrees from the planar surface of the scraping tool.

7. The machine of claim 5 where the angle between the top surface plane of the scraping tool and a line running from the front edge of the scraping tool to the intersection of the circular concave profile of the collection region and the front face of the scraping tool is between and including about 85 degrees and about 90 degrees.

8. The machine of claim 1 where the scraping tool has a lateral width between and including about 100 mm to about 200 mm.

9. The machine of claim 1 where the scraping tool, when engaged, has a force directed toward the power wheel of between about 0.110 kN and about 0.210 kN.

10. The machine of claim 1 where the surface of the power wheel at the point where said surface is in contact with the card, has a Shore A scale hardness of about 60 (A) to about 90 (A).

11. The machine of claim 2 where the Shore A scale hardness is about 70 (A) to about 90 (A).

12. The machine of claim 1 where the actuator is a solenoid mechanism that upon an electric pulse, pushes wedge to the left.

13. The machine of claim 1 where the approximately scraping tool (3.1) is mounted on a hydraulically or pneumatically driven piston or solenoid driven member that directly presses the scraping tool against the card when actuated by the PLC at the time the card is to cross the open region of the stage plate (9).

14. The machine of claim 1 further comprised of an electro-mechanical feedback subsystem.

15. The machine of claim 14 where the subsystem is comprised of an encoding wheel.

16. The machine of claim 1 further comprised of an opto-electronic sensor to detect the relative position of the card to the scraping tool.

17. The machine of claim 1 further comprising a programmable logic controller.

18. The machine of claim 17 where the programmable logic controller is adapted to engage the actuator when the card position detector detects that the edge of the film layer is proximate to the position of the scraping tool and to relax the actuator when the card position detector detects that the film layer is not proximate to the power wheel.

19. The machine of claim 1 further comprising a cleaning mechanism to remove detritus from the scraping action.

20. The machine of claim 19 where the cleaning mechanism is a rotating brush.

21. The machine of claim 19 where the cleaning mechanism is a compressed air nozzle.

22. A method of removing a film layer region comprised of a border from card stock comprising:
Passing the card stock across a scraping tool until a first predetermined position is reached;
In response to the card stock reaching the first predetermined position, reversing the direction of the card stock until a second predetermined position is reached;
In response to the card stock reaching the second predetermined position, reversing the direction of the card stock;
Prior to the trailing edge of the card stock passing the scraping tool, moving the scraping tool away from the plane of motion of the card stock.
